(19) United States
(12) Patent Application Publication
(10) Pub. No.: US 2018/0330323 A1
(43) Pub. Date: Nov. 15, 2018

(54) AUTOMATED PACKAGE DELIVERY TO UNMANNED KIOSK

(71) Applicant: Google Inc., Mountain View, CA (US)

(72) Inventors: Brandon Kyle Trew, San Francisco, CA (US); Michael Epstein, Mountain View, CA (US)

(73) Assignee: Google Inc., Mountain View, CA (US)

(21) Appl. No.: 14/275,545

(22) Filed: May 12, 2014

(51) Int. Cl. G06Q 10/08

(52) U.S. Cl. CPC G06Q 10/0836

(57) ABSTRACT

Automated package deliveries comprises a delivery drone that executes a method to receive, from a package delivery system computing device, information associated with a kiosk location for delivery of a package, the information comprising an identification of the package. The delivery device secures the package for transporting to the delivery location and transports the package to the kiosk location. The delivery device establishes a communication with the kiosk and verifies that the kiosk is associated with the identification of the package. The delivery device receives instructions from the kiosk for depositing the package in a bay of the kiosk and deposits the package in the bay of the kiosk. The kiosk receives the package from the aerial delivery device and transports the package to a package bin. The kiosk receives an input of a user authentication from the user and provides access to the package bin to the user.

### TECHNICAL FIELD

The present disclosure relates generally to automated package delivery, and more particularly to delivering packages with an aerial drone to a mechanized kiosk via an automated chute.

### BACKGROUND

Delivery services (also known as courier services, mail services, and shipping services), such as those offered by the U.S. Postal Service and commercial carriers, provide delivery of letters, packages, and parcels (hereinafter referred to as “packages”) to and from residences and businesses across the country. Other delivery services may be provided by merchants, retailers, manufacturers, or other organizations that desire to ship products to users. Typically, such services operate in hub and spoke architecture.

A typical nationwide or international delivery service maintains a large fleet of vehicles. Such vehicles include airplanes and semi-trailer trucks to move packages between hubs and spokes, and smaller vehicles for the “last mile” from spoke endpoints to delivery destinations (for example, a home or business). The two largest commercial delivery services in the U.S. together operate over 100,000 last mile vehicles—each of which requires a human operator. In some situations, interaction with a person at pickup or delivery is desired, for example, for proof of delivery, payment on delivery (also known as “cash on delivery” or “COD”), or payment of delivery costs on pickup. The growth of commercial areas, such as business-to-consumer e-commerce and online shopping, is expected to continue to increase the demand for delivery services, and hence the need for capacity and efficiency in the last mile.

Recently, package delivery systems have employed kiosks for receiving packages. The package delivery systems deliver packages to the kiosk, and a user retrieves the package directly from the kiosk. The kiosk delivery provides a safer delivery method when the user may be unavailable to receive a valuable package at the residence of the user. Additionally, unmanned aerial delivery devices are being developed for delivery of packages to users.

Conventional delivery systems do not allow packages to be delivered by unmanned aerial delivery devices to an unmanned kiosk for user pickup.

### SUMMARY

In certain example aspects described herein, a computer-implemented method for automated package delivery is provided. In an example embodiment, a delivery drone executes a method to receive, from a package delivery system computing device, information associated with a kiosk location for delivery of a package, the information comprising an identification of the package. The delivery device secures the package for transporting to the delivery location and transports the package to the kiosk location. The delivery device establishes communication with the kiosk and verifies that the kiosk is associated with the identification of the package. The delivery device receives instructions from the kiosk for depositing the package in a bay of the kiosk and deposits the package in the bay of the kiosk. The kiosk receives the package from the aerial delivery device and transports the package to a package bin. The kiosk receives an input of a user authentication from the user and verifies the user authentication based on the information associated with the package and the transmitted user authentication. The kiosk provides access to the package bin to the user.

In certain other example aspects described herein, a system and a computer program product for automated package delivery are provided.

These and other aspects, objects, features, and advantages of the example embodiments will become apparent to those having ordinary skill in the art upon consideration of the following detailed description of illustrated example embodiments.

### BRIEF DESCRIPTION OF THE DRAWINGS

FIG. 1 is a block diagram depicting a system for an aerial delivery device to deliver a package to a kiosk, in accordance with certain example embodiments.

FIG. 2 is a block flow diagram depicting a method for an aerial delivery device to deliver a package to a kiosk, in accordance with certain example embodiments.

FIG. 3 is a block flow diagram depicting a method for a package to be assigned for delivery, in accordance with certain example embodiments.

FIG. 4 is a block flow diagram depicting a method for an aerial delivery device to deposit a package, in accordance with certain example embodiments.

FIG. 5 is a block diagram depicting a computer machine and module, in accordance with certain example embodiments.

### DETAILED DESCRIPTION OF EXAMPLE EMBODIMENTS

### Overview

The example embodiments described herein provide computer-implemented techniques for providing an automated package delivery to a kiosk via a drone. In an example embodiment, an aerial delivery device, such as a drone, is transmitted instructions for delivery of a package to a kiosk. Upon arrival at the kiosk, the aerial delivery device initiates a communication with the kiosk. The kiosk opens a bay door or other access port to receive the package. The package is deposited into the bay by the aerial delivery device. The kiosk transports the package into an appropriate package bin. A user retrieves the package from the kiosk after authenticating the user identity.

In an example, a package delivery system identifies a package for delivery to a user. The package delivery system may be a warehouse depot for a merchant system or manufacturer. The package delivery system may be a courier service, a package delivery agent, or any suitable system. The package is associated with an aerial delivery device for delivery.

The user provides a preferred kiosk location for delivery of the package. The user is associated with a user identification number, a password, or other authentication data.

The package delivery system provides the kiosk location to the aerial delivery device. For example, the package delivery system provides an address for the kiosk. In another example, the package delivery system provides a global positioning system (“GPS”) location of the kiosk. Any suitable instructions that will allow the aerial delivery device to locate the kiosk may be used.

Upon arrival at the kiosk location, the aerial delivery device initiates communication with the kiosk. The communication may be transmitted via any suitable technology, such as near field communication, Bluetooth, Wi-Fi, or cellular network. After confirming that the aerial delivery device is at the correct kiosk location, the kiosk opens a bay door or other access portal. The aerial delivery device deposits the package into the bay door, confirms the delivery, and departs.

When the kiosk receives a package, the kiosk identifies the package and the associated user. The kiosk transports the package to the appropriate package bin. When the user arrives, the user enters an authentication into the user interface of the kiosk. The user is allowed access to the appropriate package bin by the kiosk. The kiosk may provide a confirmation that the user retrieved the package to the package delivery system

### Example System Architecture

Turning now to the drawings, in which like numerals indicate like (but not necessarily identical) elements throughout the figures, example embodiments are described in detail.

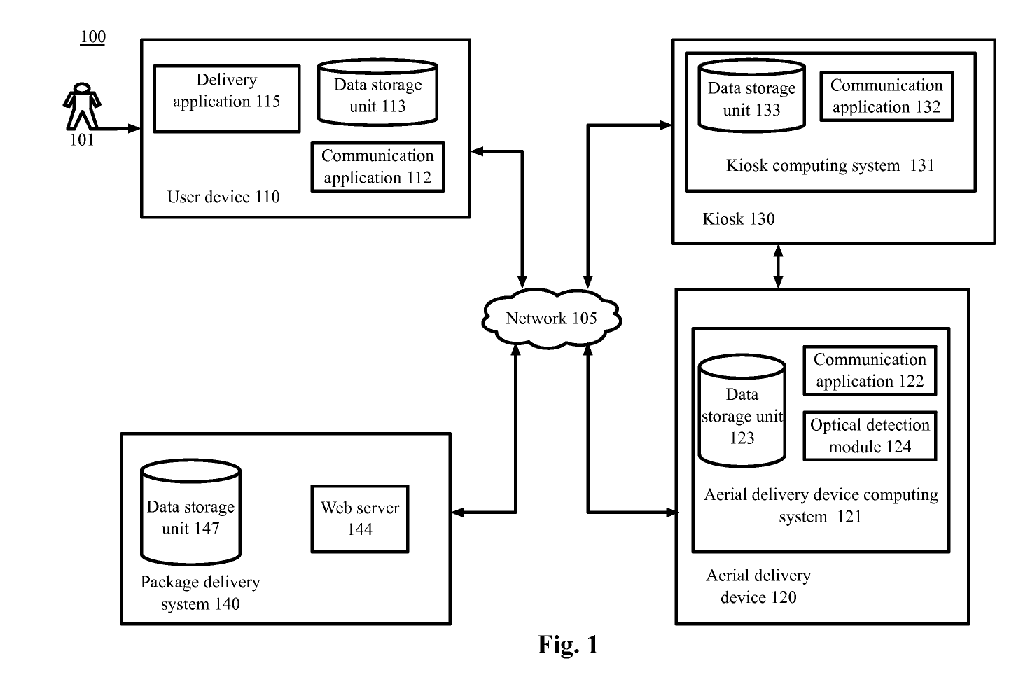

FIG. 1 is a block diagram depicting a system 100 system for an aerial delivery device 120 to deliver a package to a kiosk 130, in accordance with certain example embodiments. As depicted in FIG. 1, the system 100 includes network computing devices 110, 120, 130, and 140 that are configured to communicate with one another via one or more networks 105. In some embodiments, a user associated with a device must install an application and/or make a feature selection to obtain the benefits of the techniques described herein.

The network 105 can include a local area network (“LAN”), a wide area network (“WAN”), an intranet, an Internet, storage area network (“SAN”), personal area network (“PAN”), a metropolitan area network (“MAN”), a wireless local area network (“WLAN”), a virtual private network (“VPN”), a cellular or other mobile communication network, Bluetooth, NFC, or any combination thereof or any other appropriate architecture or system that facilitates the communication of signals, data, and/or messages. Throughout the discussion of example embodiments, it should be understood that the terms “data” and “information” are used interchangeably herein to refer to text, images, audio, video, or any other form of information that can exist in a computer-based environment.

Each network computing device 110, 120, 130, and 140 includes a device having a communication module capable of transmitting and receiving data over the network 105. For example, each network computing device 110, 120, 130, and 140 can include a server, desktop computer, laptop computer, tablet computer, a television with one or more processors embedded therein and/or coupled thereto, smart phone, handheld computer, personal digital assistant (“PDA”), or any other wired or wireless, processor-driven device. In the example embodiment depicted in FIG. 1, the network computing devices 110, 120, 130, and 140 may be operated or configured by users 101, aerial delivery device operators, kiosk operators, and package delivery system operators, respectively.

An example user computing device 110 comprises a data storage unit 113, a delivery application 115, and a communication application 112. In an example embodiment, a user interface enables the user 101 to interact with the delivery application 115 and/or the communication application 112. For example, the user interface may be a touch screen, a voice-based interface or any other interface that allows the user 101 to provide input and receive output from an application or module on the user computing device 110.

In an example embodiment, the data storage unit 113 comprises a local or remote data storage structure accessible to the user computing device 110 suitable for storing information. In an example embodiment, the data storage unit 113 stores encrypted information, such as HTML5 local storage.

In an example embodiment, the user 101 can use a communication application 112, such as a web browser application or a delivery application 115, to view, download, upload, or otherwise access documents or web pages via a distributed network 105.

In an example embodiment, the delivery application 115 is a program, function, routine, applet, or similar entity that exists on and performs operations on the user computing device 110. In certain embodiments, the user 101 must install the delivery application 115 and/or make a feature selection on the user computing device 110 to obtain the benefits of the techniques described herein. In an example embodiment, the user 101 may access the delivery application 115 on the user computing device 110 via a user interface. In an example embodiment, a user 101 signs in to the delivery application 115, which enables the user 101 to interact with the package delivery system 140, a kiosk 130 a merchant system, or other system to arrange, alter, or cancel the delivery of a product.

An example package delivery system 140 comprises a web server 144 and a data storage unit 147. In an example embodiment, the package delivery system 140 communicates with the user device 110, merchant systems, other package delivery systems, or any other person, group, or system that delivers or receives packages. In an example embodiment, user device 110 has a delivery application 115 distributed by the package delivery system 140 that enables the user 101 to access an account or information about a package. In another example embodiment, the user 101 accesses an account via the communication application 112 of the user device 110. In an example embodiment, when the user 101 accesses his account via the delivery application 115 or communication application 112, the web server 144 logs user device 110 location data.

The package delivery system 140 may represent any system that delivers or receives packages. For example, the package delivery system 140 may be a courier, a merchant system, a retailer, a shipping company, a postal service, or any suitable system.

The aerial delivery device 120 may comprise a communication application 122, and a data storage unit 123. The aerial delivery device 120 may be a drone or other unmanned vehicle. The aerial delivery device 120 maybe helicopter, quadcopter, or other aerial delivery device. The aerial delivery device 120 may alternatively be a device that does not deliver packages via flight. For example, the aerial delivery device 120 maybe a wheeled vehicle or other vehicle that delivers packages without flight.

The aerial delivery device 120 may be a drone or other unmanned vehicle. The aerial delivery device 120 may be helicopter, quadcopter, or other aerial delivery device. In alternative embodiments, a device other than an aerial delivery device can be utilized, which does not deliver packages via flight. For example, a wheeled vehicle or other vehicle that delivers packages without flight may be used.

In an example, the non-flying delivery device may utilize wheels, articulated legs, or any suitable means for propulsion. The non-flying delivery device may drive to a location, scan for the QR code 103, and proceed to the QR code 103 by rolling, walking, or via any suitable propulsion. The non-flying delivery device may deposit the package via an articulated arm, a conveyor belt, or any other suitable means.

The aerial delivery device 120 employs an aerial delivery device computing system 121. The aerial delivery device computing system 121 comprises the hardware, software, and other devices for communications, navigations, image capturing, image processing, and any other suitable computerized or automated functions.

The aerial delivery device computing system 121 comprises a communication application 122, an optical detection module 124, and a data storage unit 123. The aerial delivery device computing system 121 may utilize a communication application 122 to receive instructions for package deliveries. For example, the aerial delivery device computing system 121 may receive, via the communication application 122, delivery addresses, GPS locations, package details, or other delivery information. The aerial delivery device computing system 121 may utilize the data storage unit 123 for storing the information received via the communication application, and other suitable data.

The optical detection module 124 may be a video camera or a still camera that captures images. The optical detection module 124 may be a barcode scanner, a QR code scanner, or any suitable optical detection module 124.

The aerial delivery device computing system 121 may also comprise a navigation system, such as a global positioning system (“GPS”) or other navigation system. For example, the aerial delivery device computing system 121 may have a mapping system stored in the data storage unit 123 that works alone or in conjunction with onboard GPS technology to assist the aerial delivery device computing system 121 with navigation.

The kiosk 130 employs a kiosk computing system 131. The kiosk computing system 131 comprises the hardware, software, and other devices for communications, package handling, door controls, user interfaces, image capturing, image processing, and any other suitable computerized or automated functions.

The kiosk computing system 131 may utilize a communication application 132 to receive instructions for package deliveries. For example, the kiosk 130 may receive via the communication application 132, delivery addresses, user 101 identification, user 101 authentication information, package details, or other delivery information. The kiosk 130 may use the communication application 132 to communicate with the aerial delivery device 120 for package deliveries. The kiosk 130 may utilize the data storage unit 133 for storing the information received via the communication application 132, and other suitable data.

The kiosk 130 may be a storage kiosk comprising compartments that are locked and controlled by a kiosk computing system 131. Alternatively, the compartments may be accessible by a key, combination, or other suitable access system. The kiosk 130 may have a user interface that allows a user 101 to enter access codes, personal identification codes, delivery information, or any suitable information. The kiosk 130 may store a package for a user 101 until the user 101 is available to retrieve the package. The kiosk 130 may utilize automated machinery for transporting a package to a particular compartment. The kiosk may utilize automated doors for the bay door or other suitable doors that open automatically to receive the package, provide access to the user 101, or for other suitable purposes. The kiosk 130 may employ barcode scanners, QR code scanners, optical character recognition technology, or other suitable technology for determining the identity of a package. The kiosk 130 may a scanner or other optical reading device for capturing information from a label on the package, a sticker on the package, printed data, or any suitable available information.

In an example embodiment, the kiosk 130 may open a by door to receive a package after exchanging appropriate communications with the aerial delivery device 120. The aerial delivery device 120 hovers over the open bay door and deposits the package in to open bay door. The aerial delivery device 120 may deposit the package by detaching a hook or other retention device and allowing the package to drop away from the aerial delivery device 120. The package drops into a compartment in the kiosk 131. The bin is locked and is available to be accessed by the user 101 for retrieval of the package.

The kiosk 130 employs a kiosk computing system 131. The kiosk computing system 131 comprises the hardware, software, and other devices for communications, package handling, door controls, user interfaces, image capturing, image processing, and any other suitable computerized or automated functions.

The kiosk computing system 131 may utilize a communication application 132 to receive instructions for package deliveries. For example, the kiosk 130 may receive via the communication application 132, delivery addresses, user 101 identification, user 101 authentication information, package details, or other delivery information. The kiosk 130 may use the communication application 132 to communicate with the aerial delivery device 120 for package deliveries. The kiosk 130 may utilize the data storage unit 133 for storing the information received via the communication application 132, and other suitable data.

It will be appreciated that the network connections shown are example and other means of establishing a communications link between the computers and devices can be used. Moreover, those having ordinary skill in the art having the benefit of the present disclosure will appreciate that the user computing device 110, the aerial delivery device 120, the kiosk 130, and the package delivery system 140 illustrated in FIG. 1 can have any of several other suitable computer system configurations. For example, a user computing device 110 embodied as a mobile phone or handheld computer may or may not include all the components described above.

### Example Processes

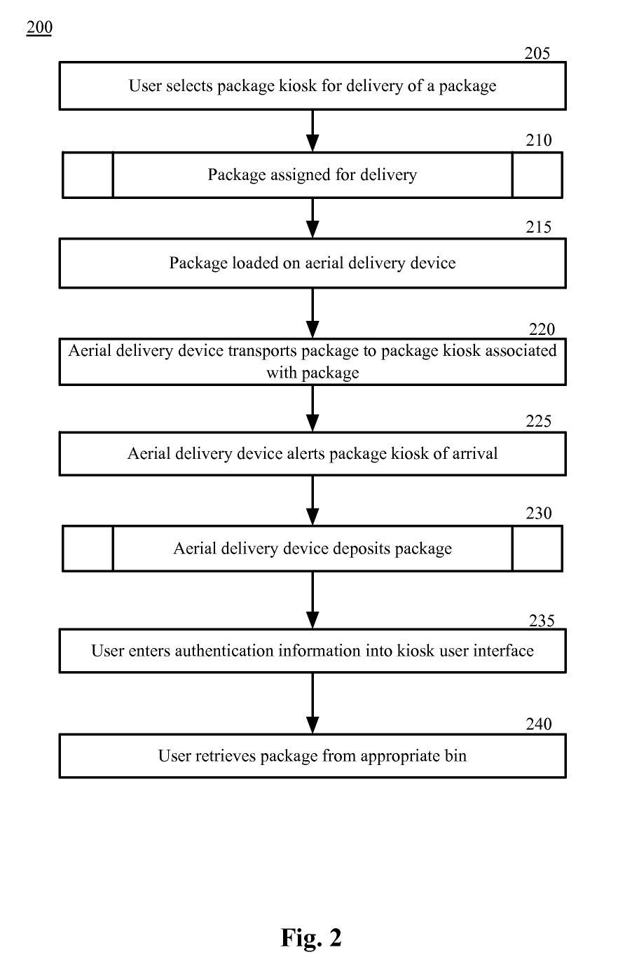

The example methods illustrated in FIGS. 2-4 are described hereinafter with respect to the components of the example operating environment 100. The example methods of FIGS. 2-4 may also be performed with other systems and in other environments.

FIG. 2 is a block diagram depicting a method 200 for an aerial delivery device to deliver a package to a kiosk, in accordance with certain example embodiments. The method 200 is described with reference to the components illustrated in FIG. 1.

In block 205, a user 101 selects a kiosk 130 for delivery of a package. The package may be any product for delivery to user 101, a merchant system, or other recipient. The package may be a product shipped from a merchant system, shipped from another user 101, shipped from a manufacturer, or may be shipped from any suitable shipper. The user 101 may select a kiosk 130 via the delivery application 115 on the user computing device 110. In an alternate embodiment, the user 101 may select the kiosk 130 on a website of the package delivery service 140. In an alternate embodiment, the user 101 may select the kiosk 130 from a merchant system, such as at the time of entering delivery information while ordering a product. Any suitable application or method may be used by the user 101 to select a delivery kiosk 130.

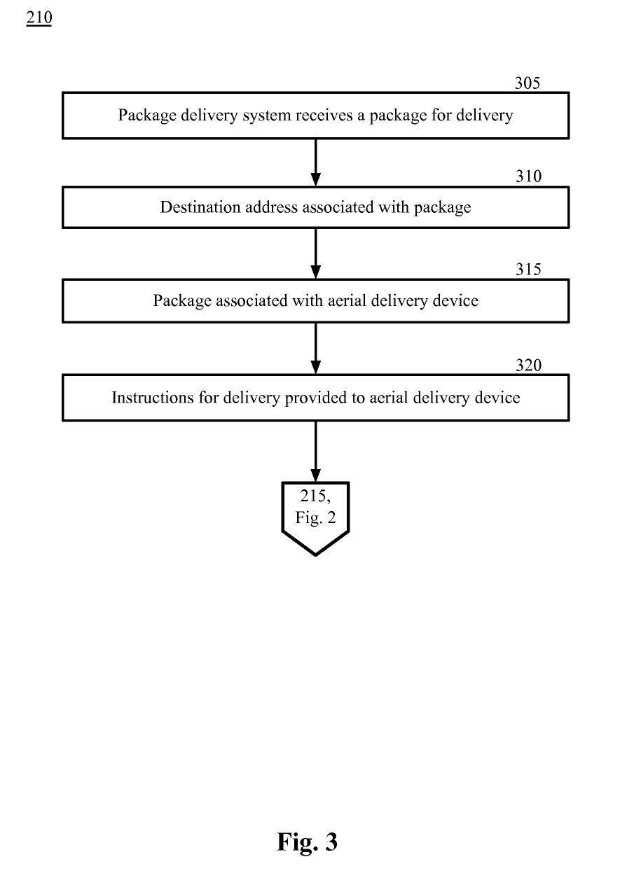

In block 210, a package is assigned for delivery. The details of block 210 are described in greater detail with respect to FIG. 3.

FIG. 3 is a block diagram depicting a method 210 for a package to be assigned for delivery, in accordance with certain example embodiments, as referenced in block 210 of FIG. 2. The method 210 is described with reference to the components illustrated in FIG. 1.

In block 305, the package delivery system 140 receives a package for delivery. The package delivery system 140 may be any system, company, organization, government service, or individual that delivers packages from one entity to another. For example, the package delivery system 140 may be a courier, postal service, package delivery company, a merchant system, a retailer, or any other suitable system that delivers packages. The package for delivery arrives at the package delivery system 140 with appropriate paperwork for delivery to a user 101. The paperwork may be in the form of digital information, a barcode, or other machine-readable code, a sticker, or any suitable paperwork comprising purchase information. The paperwork may contain a user 101 name, a user address, a confirmation number, a sender name and address, and/or other identifying information.

The delivery information associated with the package also comprises a kiosk 130 specified for delivery. The kiosk 130 information may comprise an address or other location information for the kiosk 130, a description of the capabilities of the kiosk 130, an availability of compartments in the kiosk 130, compartment sizes, and other suitable information.

In block 310, a destination address of the kiosk 130 is associated with package. For example, the package delivery system 140 obtains the address of the kiosk 130 from the paperwork associated with the package. The delivery address is stored with identification of the package in the package delivery system 140. The delivery address may be a street address, a global positioning system (“GPS”) location, or other suitable address data. Additionally, the delivery address may include directions to locate the kiosk 130 on the property at the address. For example, if the kiosk 130 is located near the northwest corner of a retail business, then the delivery address may include that exact location in the delivery address data. In a certain example embodiment, the package delivery system 140 identifies the kiosk 130 nearest to the address of the user 101 and selects the identified kiosk 130 as the delivery kiosk 130.

In block 315, the package delivery system 140 associates the package with an aerial delivery device 120. The package delivery system 140 may identify an aerial delivery device 120 that is associated with a delivery area in which the kiosk address is located. For example, certain aerial delivery devices 120 may be assigned a delivery route that encompasses a particular geographic region. If the kiosk address is located in that geographic region, then the package may be associated with that particular aerial delivery device 120. In an alternate embodiment, the package is associated with the aerial delivery device 120 that is next in a queue of aerial delivery devices 120.

In block 320, the instructions for delivery of the package are provided to the aerial delivery device computing system 121. In an example embodiment, the instructions are delivered to the communication application 122 of the aerial delivery device computing system 121 via near field communication, Bluetooth, Wi-Fi, or any available communication. The instructions may be transmitted to the aerial delivery device computing system 121 by a computing system associated with the package delivery system 140. In an example, an operator of the package delivery system 140 may direct a computing system to deliver the instructions, or the operator may enter the instructions directly into a user interface of the aerial delivery device computing system 121. Any suitable manner of transmitting the instructions to the aerial delivery device computing system 121 may be used.

The package delivery system 140 provides to the aerial delivery device computing system 121 an address for the kiosk 130. In another example, the package delivery system provides a GPS location to the aerial delivery device. Additionally, the aerial delivery device computing system 121 is provided with instructions for communicating with the kiosk computing system 131 upon arrival, such as the preferred communication technology, an authorization code, or any other suitable information. Any other suitable instructions that will allow the aerial delivery device to locate the delivery location may be used.

From block 320, the method 210 returns to block 215 of FIG. 2.

Returning to FIG. 2, in block 215, the package is loaded onto the aerial delivery device 120. The package may be loaded in in any suitable manner that allows the aerial delivery device 120 to transport the package to the delivery location. For example, the aerial delivery device 120 may be equipped with a platform for supporting the package during transit. In another example, the aerial delivery device 120 may support the package with a strap, a hook, an attached net, or with any suitable attachment device. The package may be loaded with an automated packaging process. In this example, the aerial delivery device 120 may be positioned under an automated package sorter that drops the package from a sorting chute. The package drops onto a platform of the aerial delivery device 120 that supports packages for transfer to delivery locations. Alternatively, the package may be loaded manually by an operator at the package delivery system 140. The aerial delivery device computing system 121 may receive a digital confirmation of the package's identification from an operator or a computing system of the package delivery system 140.

In block 220, the aerial delivery device 120 transports the package to the kiosk address associated with the delivery. For example the aerial delivery device 120 may fly to the address via a predetermined route. The aerial delivery device computing system 121 may use a mapping program to proceed to the address. The aerial delivery device computing system 121 may utilize a global positioning system (“GPS”) technology for locating the address of user 101. The aerial delivery device 120 may be transported a portion of the distance to the delivery address by a separate vehicle. For example, a delivery truck may deliver multiple aerial delivery devices 120 to within a location that is central to multiple kiosk delivery addresses. The aerial delivery device 120 then leaves the delivery truck and travels the remaining distance with the package.

In an example embodiment, the aerial delivery device 120 arrives at the address of the kiosk 130 when the aerial delivery device 120 is on or above the street directly in front of the kiosk at the address. In another example, the aerial delivery device 120 hovers over the property located at the address.

In block 225, the aerial delivery device computing system 121 alerts the kiosk computing system 131 of arrival. The aerial delivery device computing system 121 communicates wirelessly with the kiosk computing system 131. The communication application 122 of the aerial delivery device computing system 121 may use a communication technology such as near field communication (“NFC”), Wi-Fi, Bluetooth, RFID, cellular, or any suitable communication technology. The preferred communication technology for a particular kiosk computing system 131 may be included in the delivery instructions received from the package delivery service 140. The communication application 132 of the kiosk computing system 131 and the communication application 122 of the aerial delivery device computing system 121 may exchange authentication information or other information to verify the delivery information.

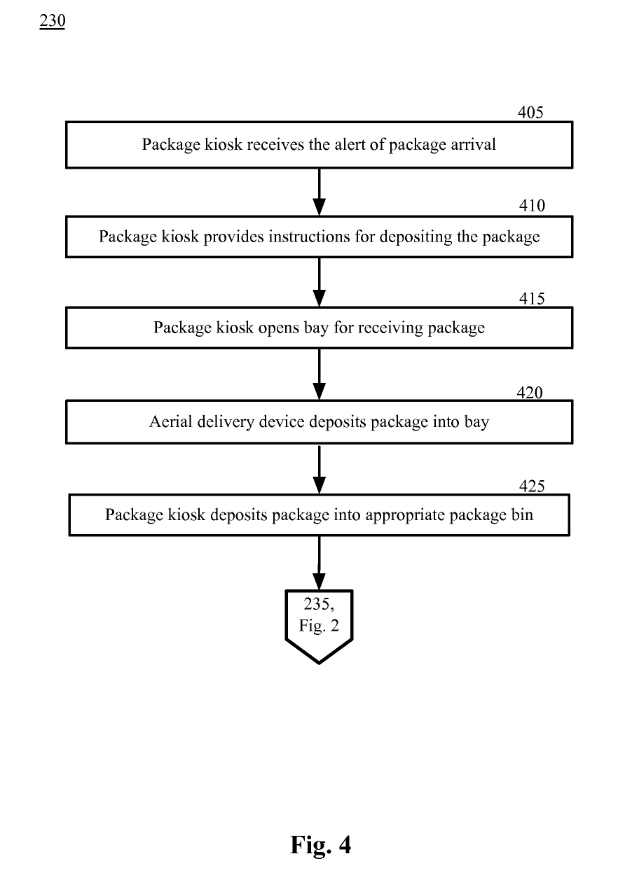

In block 230, the aerial delivery device 120 deposits the package. Block 230 is described in greater detail in the method 230 of FIG. 4.

FIG. 4 is a block flow diagram depicting a method 230 for an aerial delivery device 120 to deposit the package, in accordance with certain example embodiments, as referenced in FIG. 4. The method 230 is described with reference to the components illustrated in FIG. 1.

In block 405, the kiosk computing system 131 receives the communicated alert of the package arrival from the aerial delivery device computing system 121. The aerial delivery device computing system 121 transmits, over the communication technology, a message that an expected package has arrived and is available for deposit into the kiosk 130. The kiosk computing system 131 transmits an acknowledgment that the package is at the appropriate kiosk 130. The kiosk computing system 131 may receive the package information from aerial delivery device computing system 121 and confirm the delivery information for the package. For example, the kiosk computing system 131 may communicate with the package delivery service 140 or the user computing device 110 to verify that the package is configured to be delivered to the kiosk 130.

In block 410, the kiosk computing system 131 provides instructions for depositing the package. For example, the kiosk computing system 131 may provide, to the aerial delivery device computing system 121, an approach route from the street that will provide the safest flight path. In another example, the kiosk computing system 131 provides instructions for locating the package receiving bay of the kiosk 130. In an alternative embodiment, the kiosk computing system 131 may provide a continuous wireless signal to the aerial delivery device computing system 121 that will guide the aerial delivery device 120 to the kiosk 130 location. In another example, the kiosk computing system 131 provides information regarding procedures required to deposit a package into the bay.

In block 415, the kiosk 130 opens the bay for receiving the package. The bay may be a landing pad on the kiosk 130, a chute for receiving the package, a retractable door, or any suitable receptacle for receiving the package. The bay may be opened or otherwise prepared by activating a mechanical door, an automated landing platform, or any suitable mechanism.

In block 420, the aerial delivery device 120 deposits the package into the bay. For example, the aerial delivery device 120 may hover over the bay and lower the package via a retractable line or cable into the bay of the kiosk 130. The aerial delivery device 120 may release the line or cable by transmitting a communication to a clasp, hook, or other device to release. The aerial delivery device 120 may proceed to move away from the bay with the package no longer attached, or the line or cable may retract into the aerial delivery device 120 with the package no longer attached. In another example, the aerial delivery device 120 hovers over the delivery platform and releases the package allowing the package to drop to a delivery platform or into the bay. The aerial delivery device 120 may deposit the package in any suitable manner.

The bay may employ a platform for receiving the package instead of an open chute or bay. After receiving the package on a platform, the kiosk 130 transports the package inside the kiosk 130. For example, the kiosk computing system 131 may activate a conveyor belt or other mechanical means to transport the package.

In block for 425, the kiosk 130 deposits the package into the appropriate package bin. For example, the kiosk computing system 131 employees an automated mechanical means for transporting the package to the appropriate bin. The kiosk computing system 131 may utilize a series of conveyor belts, electro-hydraulic grabbers, robotic handling equipment, automated storage and retrieval systems, or other means of transporting the package into the appropriate bin.

From block 425, the method 230 returns to block 235 of FIG. 2.

Returning to FIG. 2, in block 235, the user 101 enters authentication information into the user interface the kiosk computing system 131. In an example, the kiosk computing system 131, the aerial delivery device computing system 121, the package delivery service 140, a merchant system, or other suitable party alerts the user computing device 110 that the package is available for retrieval at the kiosk 130. The user 101 approaches the kiosk 130 and accesses the user interface. The user interface of the kiosk computing system 131 may be a touchscreen interface, an alphanumeric keypad, a voice activated interface, or other suitable user interface. The user 101 enters an authentication code to access the kiosk bin. The authentication code maybe a code is associated with the user 101 such as a password or personal identification number. The code may be configured for use by the user 101 for all package retrievals. Alternatively, the code may be a single use code that was established at the time of the delivery arrangement.

In block 240, if the user code is authenticated then the kiosk computing system 131 grants access to the user 101 to be appropriate bin. In an example, the kiosk computing system 131 transmits a signal to the locking device of the bin causing the bin to open. In another example, the user interface of the kiosk computing system 131 provides information, such as a combination code, allowing the user 101 to open the bin. Any other suitable manner of allowing the user 101 access to the bin may be used.

The user 101 retrieves the package from the bin. The kiosk computing system 131 logs the retrieval of the package by the user 101. The kiosk computing system 131 notifies the package delivery system 140, the user computing device 110, a merchant system, or other suitable party that the package has been retrieved.

### Other Example Embodiments

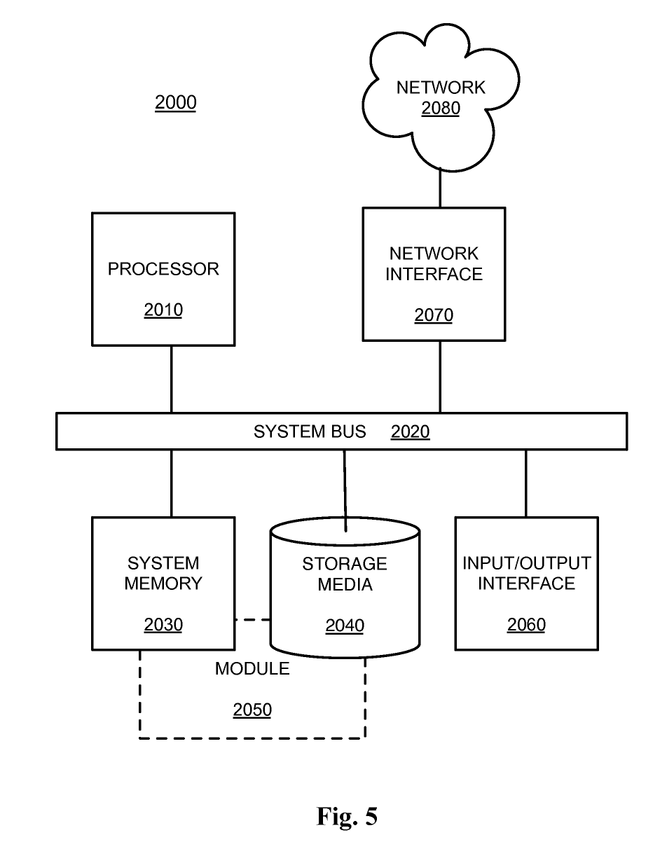

FIG. 5 depicts a computing machine 2000 and a module 2050 in accordance with certain example embodiments. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a vehicular information system, a television with one or more processors embedded therein and/or coupled thereto, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 2030 may also include volatile memories such as random access memory (“RAM”), static random access memory (“SRAM”), dynamic random access memory (“DRAM”), and synchronous dynamic random access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read only memory (“CD-ROM”), a digital versatile disc (“DVD”), a Blu-ray disc, a magnetic tape, a flash memory, other non-volatile memory device, a solid state drive (“SSD”), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to some embodiments, any of the processor 2010, the other elements of the computing machine 2000, or the various peripherals discussed herein may be integrated into a single device such as a system on chip (“SOC”), system on package (“SOP”), or ASIC device.

In situations in which the systems discussed here collect personal information about users, or may make use of personal information, the users may be provided with an opportunity or option to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described herein. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the invention claimed herein.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

1. A computer-implemented method to deliver packages by an unmanned delivery device to unmanned kiosks and store the packages in one or a plurality of compartments for retrieval by users, comprising:
receiving, by one or more computing devices, a request for a package delivery, the request comprising an identification of a package and an identification of an unmanned kiosk location for delivery;
associating, by the one or more computing devices, the package with an unmanned delivery device;
associating with the package, by the one or more computing devices, a user authentication to retrieve the package;
transmitting to the delivery device, by the one or more computing devices, information associated with the kiosk location comprising the kiosk location and information associated with the package;
transmitting to the kiosk, by the one or more computing devices, the identification of the package and the user authentication to retrieve the package;
receiving, by the kiosk, a communication from the delivery device, the communication comprising an identification of the delivery device and the identification of the package;
preparing, by the kiosk, a bay for receiving the package from the delivery device;
transmitting, by the kiosk to the delivery device, a approach route to the bay;
receiving, by the kiosk, the package at the prepared bay from the delivery device;
transporting, by an unmanned, mechanical mechanism of the kiosk, the package from the prepared bay to a particular one of a plurality of package bins, the particular one of the plurality of package bins being associated with the user authentication;
receiving, by the kiosk, an input of the user authentication from the user;
verifying, by the kiosk, the user authentication based on the identification of the package and the received user authentication; and
providing, by the kiosk, access to the particular package bin to the user based on the verified user authentication.

2. (canceled)

3. The method of claim 1, wherein the information associated with the kiosk location comprises a GPS location of the kiosk.

4. The method of claim 1, wherein the identification of a kiosk location for delivery comprises an address of the kiosk.

5. The method of claim 1, further comprising transmitting, by the kiosk, instructions to the delivery device to deposit the package in the bay.

6. The method of claim 1, wherein the transporting of the package to the particular package bin is performed by an automated mechanical system.

7. The method of claim 1, further comprising receiving, by the one or more computing devices, a verification from the kiosk that the package has been retrieved by the user.

8. A system for automated package deliveries by unmanned delivery devices, comprising:
a storage device for a delivery device; and
a processor communicatively coupled to the storage device, wherein the processor executes application code instructions that are stored in the storage device to cause the system to:
receive, from a package delivery system computing device, information associated with a kiosk location for delivery of a package, the information comprising an identification of the package;
secure the package for transporting to the delivery location;
transport the package to the kiosk location;
establish a communication with the kiosk;
verify that the kiosk is associated with the identification of the package;
receive instructions from the kiosk for depositing the package in a bay of the kiosk; and
deposit the package in the bay of the kiosk.

9. The system of claim 8, further comprising:
a storage device for a kiosk; and
a processor communicatively coupled to the storage device for the kiosk, wherein the processor executes application code instructions that are stored in the storage device to cause the system to:
receive a communication from the delivery device, the communication comprising an identification of the delivery device and information associated with the package;
prepare a bay for receiving the package from the aerial delivery device;
receive the package from the aerial delivery device;
transport the package to a package bin;
receive an input of a user authentication from the user;
verify the user authentication based on the information associated with the package and the transmitted user authentication; and
provide access to the package bin to the user.

10. The system of claim 8, wherein the information associated with the kiosk location comprises a GPS location of the kiosk.

11. The system of claim 8, wherein the information associated with the kiosk location comprises an address of the kiosk.

12. The system of claim 9, further comprising transmitting instructions to the delivery device to deposit the package in the bay

13. The system of claim 9, wherein the transporting of the package to a package bin is performed by an automated mechanical system.

14. A computer program product, comprising:
a non-transitory computer-readable medium having computer-executable program instructions embodied thereon that when executed by a computer cause the computer to deliver packages to unmanned kiosks and store the packages in one or a plurality of compartments for retrieval by users, the computer-executable instructions comprising:
computer-executable program instructions to receive a request for a package delivery, the request comprising an identification of a package and an identification of an unmanned kiosk location for delivery;
computer-executable program instructions to transmit, to an aerial delivery device, information associated with the kiosk location comprising the kiosk location and information associated with the package;
computer-executable program instructions to associate a user authentication with the package;
computer-executable program instructions to receive a communication from the aerial delivery device, the communication comprising an identification of the aerial delivery device and information associated with the package;
computer-executable program instructions to prepare a bay for receiving the package from the aerial delivery device;
computer-executable program instructions to transmit, to the delivery device, a approach route to the bay;
computer-executable program instructions to receive the package from the aerial delivery device;
computer-executable program instructions to engage an unmanned mechanical mechanism to transport the package to a particular one of a plurality of package bins;
computer-executable program instructions to receive an input of the user authentication from the user;
computer-executable program instructions to verify the user authentication based on the information associated with the package and the received user authentication; and
computer-executable program instructions to provide access to the particular package bin to the user.

15. The computer program product of claim 14, further comprising computer-readable program instructions to transmit instructions to the aerial delivery device to deposit the package in the bay.

16. The computer program product of claim 14, wherein the transporting of the package to the particular one of the plurality of package bins is performed by an automated mechanical system.

17. The computer program product of claim 14, further comprising computer-readable program instructions to a verification that the package has been retrieved by the user.
